(19) United States
(12) Patent Application Publication
(10) Pub. No.: US 2010/0033077 A1
(43) Pub. Date: Feb. 11, 2010

(54) LIGHT EMITTING DEVICE AND METHOD OF MANUFACTURING THE LIGHT EMITTING DEVICE

(75) Inventors: Wei Shen, Changhua Hsien (TW); Yuan-Lin Lee, Changhua Hsien (TW); Yu-Chien Yang, Changhua Hsien (TW)

Correspondence Address: WPAT, PC;INTELLECTUAL PROPERTY ATTORNEYS, 2030 MAIN STREET, SUITE 1300, IRVINE, CA, 92614, US

(73) Assignee: GLORY SCIENCE CO., LTD., Changhua Hsien (TW)

(21) Appl. No.: 12/188,983

(22) Filed: Aug. 8, 2008

(51) Int. Cl. H01J 1/62; H01J 9/02

(52) U.S. Cl. 313/498; 445/50

(57) ABSTRACT

A method of manufacturing a light emitting device includes steps of setting a threshold of luminous intensity, measuring luminous intensity of a measured light emitting device, calculating an offset value between the threshold of luminous intensity and the measured luminous intensity, performing a destruct structure capable of decreasing energy of light beam on an optical element of the measured light emitting device, wherein the energy decreasing efficiency of the destruct structure is direct proportion to the offset value. While the light beam is radiated from a light emitting chip of the measured light emitting device and to the destruct structure, few light energy is absorbed or scattered by the destruct structure to decrease the luminous intensity. Therefore, the light emitting device with the destruct structure has a consistent luminous intensity due to the energy decreasing efficiency of the destruct structure is direct proportion to the offset luminous intensity.

### BACKGROUND OF THE INVENTION

1. Field of the Invention

The present invention relates to a light emitting device and, more particularly, to a method of manufacturing a light emitting device with a consistent luminous intensity.

2. The Related Art

Nowadays, a backlight module is a necessary component used in a display device for emitting light beam. Base on standards of RoHS, light emitting diodes (LED) have replaced cold cathode fluorescent lamps (CCFL) used in backlight module and used for light source.

A large size backlight module, for example, the dimension thereof is larger than 20 inch, is used in a television. A middle size backlight module, for example, the dimension thereof is smaller than 17 inch and larger than 12 inch, is used in a monitor of a laptop. A small size liquid crystal display device, for example, the dimension thereof is smaller than 10 inch, is used in a mobile phone, a personal digital assistant, a digital camera and etc.

Usually, the backlight module has many LEDs arranged in line or array for emitting sufficient luminous intensity. According to consideration of distribution of luminous intensity of the backlight module, all LEDs used in backlight module are needed to equip a consistent luminous intensity.

In order to manufacture a backlight module of which distribution of luminous intensity is uniform, picking and choosing LEDs equipped with a consistent luminous intensity is a necessary procedure before manufacturing the backlight module. However, the cost raised due to the LEDs of which luminous intensity are different to the consistent luminous intensity are weeded out.

### SUMMARY OF THE INVENTION

An object of the present invention is to provide a light emitting device having a base, a light emitting chip, a reflecting cap and a destruct structure. The light emitting chip is mounted on the base and defines a light emitting surface thereon. The reflecting cap is mounted on the base and receives the light emitting chip therein. The destruct structure is formed on the light emitting surface of the light emitting chip.

Another object of the present invention is to provide a method of manufacturing the light emitting device. The manufacturing method includes:
step 1: setting a threshold of luminous intensity;
step 2: measuring a luminous intensity of a measured light emitting unit;
step 3: calculating an offset value between the threshold of luminous intensity and the measured luminous intensity of the measured light emitting unit; and
step 4: performing a destruct structure capable of decreasing energy of light beam passed therethrough on a surface of an optical element of the measured light emitting device, wherein the energy decreasing efficiency of the destruct structure is direct proportion to the offset value.

While the light beam is radiated from the light emitting chip of the measured light emitting device and to the destruct structure, few light energy is absorbed or scattered by the destruct structure to decrease the luminous intensity. Therefore, the light emitting device with the destruct structure has a consistent luminous intensity due to the light absorbing ratio or the light scattering coefficient of the destruct structure is direct proportion to the offset luminous intensity.

### BRIEF DESCRIPTION OF THE DRAWINGS

The present invention will be apparent to those skilled in the art by reading the following description of preferred embodiments thereof, with reference to the attached drawings, in which:

FIG. 1 is a section view showing a first embodiment of a light emitting device according to the present invention;

FIG. 2 is a section view showing a second embodiment of the light emitting device according to the present invention;

FIG. 3 is a flow chart showing a method of manufacturing the light emitting device according to the present invention;

FIG. 4 is a flow chart showing a method of manufacturing a destruct structure by laser beam according to the present invention;

FIG. 5 is a flow chart showing a method of manufacturing the destruct structure by micro sand blasting according to the present invention;

FIG. 6 is a section view showing a third embodiment of the light emitting device according to the present invention;

FIG. 7 a section view showing a fourth embodiment of the light emitting device according to the present invention;

FIG. 8 a section view showing a fifth embodiment of the light emitting device according to the present invention; and

FIG. 9 is a section view showing a sixth embodiment of the light emitting device according to the present invention.

### DETAILED DESCRIPTION OF THE PREFERRED EMBODIMENT

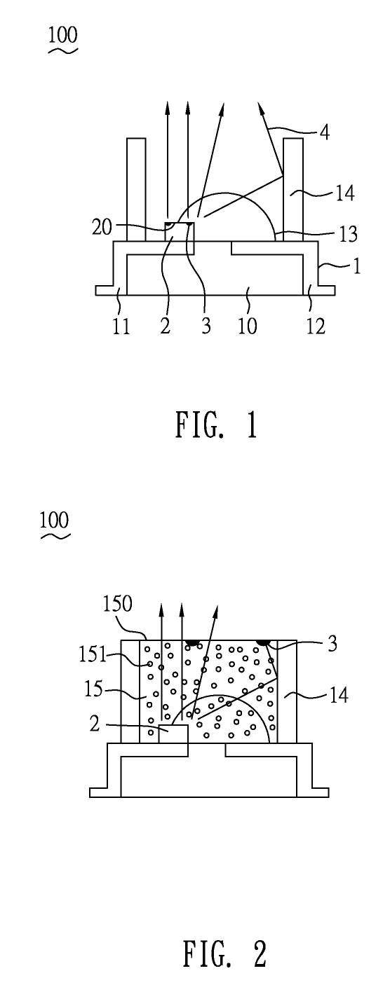

Please refer to FIG. 1, showing a first exemplary embodiment of a light emitting device 100. The light emitting device 100 has a base 1, a light emitting chip 2 positioned on a top surface of the base 1 and at least one destruct structure. The base 1 has a substrate 10, a first metallic contact 11, a second metallic contact 12, a wire bond 13 and a reflecting cap 14.

The first metallic contact 11 and the second metallic contact 12 are disposed on a top surface of the substrate 10. The light emitting chip 2 defines a first light emitting surface 20 on a top surface thereof, which is mounted on and contacts to the first metallic contact 11. The wire bond 13 interconnects between the light emitting chip 2 and the second metallic contact 12. The reflecting cap 14 is mounted on the top surface of the substrate 10, in which are the light emitting chip 2 and the wire bond 13. Specially, the destruct structure is a scorching artifact 3 formed on the first light emitting surface 20 of the light emitting chip 2.

A power source can be coupled to the first metallic contact 11 and the second metallic contact 12, and then the light emitting chip 2 is caused to radiate light beam. The light beam radiates outwardly from the first light emitting surface 20 of the light emitting chip 2 to define a luminous path 4 (tracks of arrows in the figures).

Please refer to FIG. 2, showing a second exemplary embodiment of the light emitting device 100. The light emitting device 100 further has an encapsulant 15. The encapsulatnt 15 is formed in the reflecting cap 14 and encapsulates the light emitting chip 2 to define a second light emitting surface 150. The scorching artifact 3 is formed on the second light emitting surface 150 of the encapsulatnt 15. Specifically, the encapsulant 15 is made of a transparent resin or mixed with phosphors 151.

If the encapsulant 15 is made of the transparent resin, the light beam is radiated from the light emitting chip 2, through the encapsulant 15 directly and then outwardly from the second light emitting surface 150. If the encapsulant 15 is made of the transparent resin mixed with the phosphors 151, the light beam radiated from the light emitting chip 2 is excited and reflected by the phosphors 151 to alter frequency spectrum thereof, and then the altered light beam is radiated outwardly from the second light emitting surface 150.

Specifically, the frequency spectrum of the light beam radiated from the light emitting surface 150 of the light emitting unit 100 can be controlled by choosing the frequency spectrum of the light beam emitted from the light emitting chip 2 and the phosphors 151.

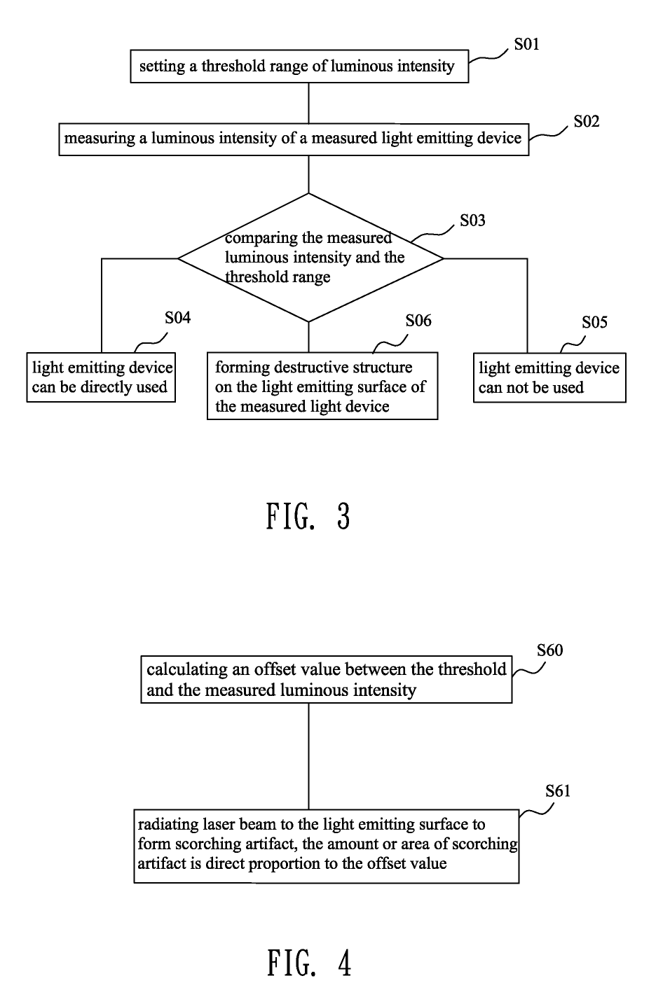

Please refer to FIG. 3, a flow chart of a method of manufacturing the light emitting device 100 is shown. The manufacturing method includes the following steps:
S01: previously setting a threshold range of luminous intensity;
S02: measuring a luminous intensity of a measured light emitting device;
S03: comparing the measured luminous intensity of the measured light emitting device and the threshold range of the luminous intensity, while the measured luminous intensity of the measured light emitting device is included in the threshold range of the luminous intensity, S04 is performed, while the measured luminous intensity of the measured light emitting device is below the threshold range of the luminous intensity, S05 is performed, while the measured luminous intensity of the measured light emitting device is over the threshold range of the luminous intensity, S06 is performed;
S04: the measured light emitting unit can be directly used;
S05: the measured light emitting unit can not be used; and
S06: forming the scorching artifact 3 on the first light emitting surface 20 of the light emitting chip 2 of the measured light emitting device or on the second light emitting surface 150 of the encapsulant 15 of the measured light emitting device, to decrease the luminous intensity of the measured light emitting device, to make the luminous intensity of the measured light emitting device with the scorching artifact 3 is in the threshold range of luminous intensity.

Please refer to FIG. 4, showing a flow chart of a method of manufacturing the scorching artifact 3 by laser beam. The manufacturing method includes the following steps:
S60: calculating an offset value between the threshold of luminous intensity and the measured luminous intensity of the measured light emitting device; and
S61: radiating laser beam with sufficient energy to the first light emitting surface 20 of the light emitting chip 2 or the second light emitting surface 150 of the encapsulant 15 to form at least one scorching artifact 3, wherein the amount or area of the scorching artifact 3 is direct proportion to the offset value.

In an instance, the threshold of the luminous intensity is set to 100 lm/w (lumen per watt). The threshold range of luminous intensity is set to one percent, therefore, the threshold range of luminous intensity is from 99 lm/w to 101 lm/w. While the luminous intensity of the measured light emitting device is over 101 lm/w, at least one scorching artifact 3 is formed on the first light emitting surface 20 of the light emitting chip 2 or on the second light emitting surface 150 of the encapsulant 15 by radiating laser beam with sufficient energy.

Specifically, the laser beam can be aimed at the phosphor 151 for damaging the phosphor 151. Therefore, the light beam radiated from the light emitting chip 2 can not be excited and reflected by the damaged phosphors 151. Therefore, the luminous intensity of the light emitting device 100 is decreased.

The measured light emitting device is directly used while the luminous intensity thereof is in the threshold range of the luminous intensity. The first light emitting surface 20 of the light emitting chip 2 or the second light emitting surface 150 of the encapsulant 15 of the measured light emitting device forms the scorching artifact 3 by radiating laser beam with sufficient energy thereon while the luminous intensity of the measured light emitting device is over the threshold range of the luminous intensity.

The amount or area of the scorching artifact 3 with respect to a light absorbing ratio is direct proportion to the offset value between the threshold of the luminous intensity and the measured luminous intensity. While the light beam radiated from the light emitting chip 2 passes through the scorching artifact 3, few light energy is absorbed by the scorching artifact 3 to decrease the luminous intensity of the light emitting device 100.

The amount of the absorbed light energy is with respect to the light absorbing ratio of the scorching artifact. Therefore, the light emitting device 100 with the scorching artifact 3 has a consistent luminous intensity.

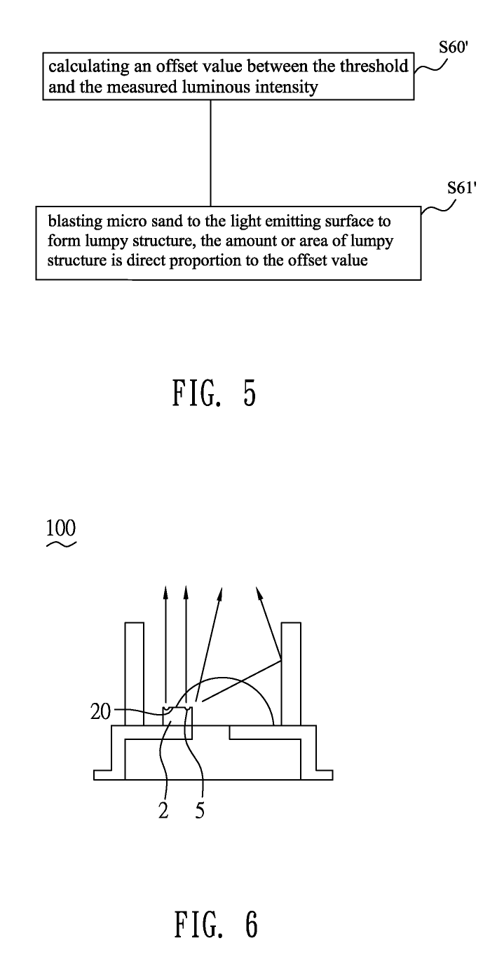

Please refer to FIG. 5, a flow chart of a method of manufacturing the destruct structure by micro sand blasting is shown. The manufacturing method includes the following steps:
S60′: calculating an offset value between the threshold of luminous intensity and the measured luminous intensity of the measured light emitting device; and
S61′: blasting micro sand to the first light emitting surface 20 of the light emitting chip 2 or the second light emitting surface 150 of the encapsulant 15 to form at least one lumpy structure 5, wherein the amount or area of the lumpy structure 5 is direct proportion to the offset value.

In another instance, the threshold of the luminous intensity is set to 100 lm/w. The threshold range of luminous intensity is set to one percent, therefore, the threshold range of luminous intensity is from 99 lm/w to 101 lm/w. While the luminous intensity of the measured light emitting device is over 101 lm/w, at least one lumpy structure 5 is formed on the first light emitting surface 20 of the light emitting chip 2 or on the second light emitting surface 150 of the encapsulant 15 by micro sand blasting.

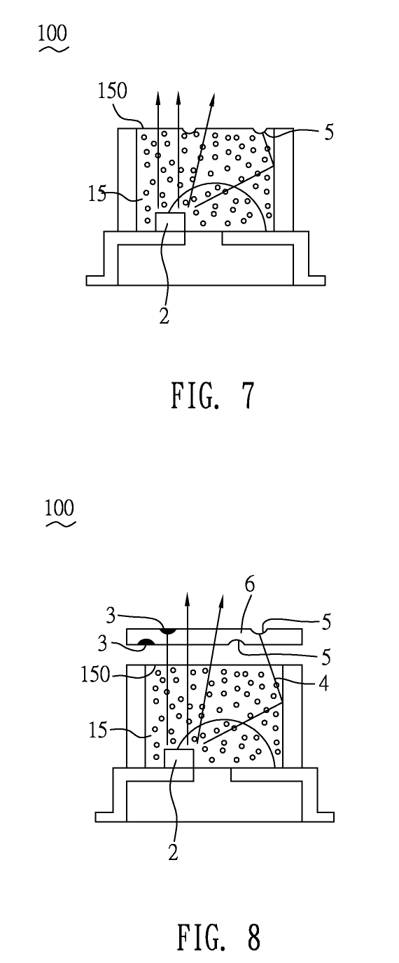

Please refer to FIG. 6, showing a third exemplary embodiment of the light emitting device 100. The light emitting device 100 has at least one lumpy structure 5 formed on the first light emitting surface 20 of the light emitting chip 2 thereof. Please refer to FIG. 7, showing a fourth exemplary embodiment of the light emitting device 100. The light emitting device 100 has at least one lumpy structure 5 formed on the second light emitting surface 150 of the encapsulant 15 thereof.

The amount or area of the lumpy structure 5 with respect to a light scattering coefficient is direct proportion to the offset value between the threshold of the luminous intensity and the measured luminous intensity. While the light beam radiated from the light emitting chip 2 passes through the lumpy structure 5, few light beam is scattered to decrease the light energy.

The light emitting device 100 with the lumpy structure 5 has a consistent luminous intensity due to the amount of the scattered light beam is with respect to the light scattering coefficient of the lumpy structure 5.

Please refer to FIG. 8, showing a fifth exemplary embodiment of a light emitting device 100. The light emitting device 100 further includes a plate-like transparent optical element 6, such as transparent glass, positioned in the luminous path 4. The destruct structure is formed on at least one surface of the transparent optical element 6. The transparent optical element 6 is parallelly positioned upon and apart from the second light emitting surface 150. Furthermore, the transparent optical element 6 can be connected onto the second light emitting surface 150.

Specifically, the transparent optical element 6 can be made of glass material or plastic material. The destruct structure formed on the transparent optical element 6 can be the scorching artifact 3 or the lumpy structure 5.

The light beam radiated from the light emitting chip 2 is radiated outwardly from the second light emitting surface 150 and then through the transparent optical element 6. Due to few of light beam is radiated to the destruct structure to decrease light energy, the luminous intensity of the light emitting device 100 is decreased.

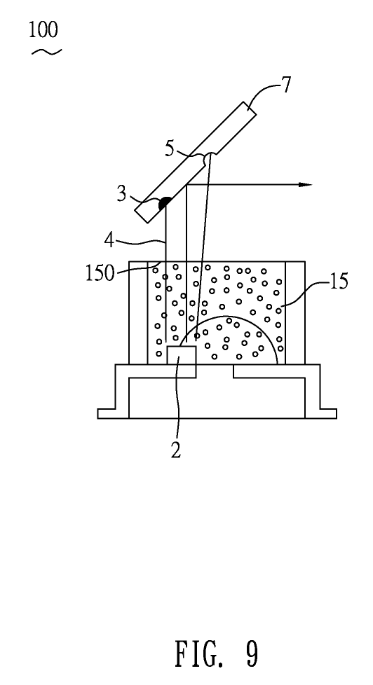

Please refer to FIG. 9, showing a sixth exemplary embodiment of the light emitting device 100. The light emitting device 100 further includes a plate-like light reflecting element 7 positioned in the luminous path 4. The destruct structure is formed on at least one surface of the light reflecting element 7. The light reflecting element 7 is obliquely positioned upon and apart from the second light emitting surface 150. The destruct structure formed on the light reflecting element 7 can be the scorching artifact 3 or the lumpy structure 5.

The light beam radiated from the light emitting chip 2 is radiated outwardly from the light emitting surface 150, and reflected by the light reflecting element 7. While few of light beam is radiated to the destruct structure to decrease light energy, the luminous intensity of the light emitting device 100 is therefore decreased.

In another instance, many transparent optical elements 6 and light reflecting elements 7 with distinct amount or area of destruct structure are previously prepared. After the luminous intensity of the measured light emitting device is measured and the offset value is calculated, one transparent optical element 6 or one light reflecting element 7, of which the amount or area of destruct structure is with respect to the offset value, is chosen from the transparent optical elements 6 or the light reflecting elements 7. The corresponding transparent optical element 6 or light reflecting element 7 and the measured light emitting device are assembled.

The destruct structure, such as the scorching artifact 3 and the lumpy structure 5, is formed on the surface of the light emitting chip or the optical element, such as the encapsulant 15, the transparent optical element 6 and the light reflecting element 7, by micro sand blasting or radiating leaser beam.

The amount or area of the destruct structure with respect to the light absorbing ratio or the light scattering coefficient is direct proportion to the offset value between the threshold of luminous intensity and the original luminous intensity of the light emitting device 100.

While the light beam is radiated from the measured light emitting device and to the destruct structure, few light energy is absorbed or scattered by the destruct structure to decrease the luminous intensity. Therefore, the light emitting device 100 with the destruct structure has a consistent luminous intensity due to the light absorbing ratio or the light scattering coefficient of the destruct structure is direct proportion to the offset luminous intensity.

Furthermore, the present invention is not limited to the embodiments described above; various additions, alterations and the like may be made within the scope of the present invention by a person skilled in the art. For example, respective embodiments may be appropriately combined.

What is claimed is:

1. A light emitting device, comprising:
a base;
a light emitting chip mounted on said base and defining a light emitting surface;
a reflecting cap mounted on said base and receiving said light emitting chip therein; and
a destruct structure formed on said light emitting surface of said light emitting chip.

2. The light emitting device as claimed in claim 1, wherein said destruct structure is a scorching artifact or a lumpy structure.

3. The light emitting device as claimed in claim 1, wherein said base comprises:
a substrate;
a first metallic contact disposed on a top surface of said substrate, said light emitting chip mounted on and connected to said first metallic contact;
a second metallic contact disposed on said top surface of said substrate;
a wire bone interconnected between said light emitting chip and said second metallic contact; and
an encapsulant formed in said reflecting cap and encapsulating said light emitting chip.

4. A light emitting device, comprising:
a base;
a light emitting chip mounted on said base for radiating light beam defining a luminous path;
a reflecting cap mounted on said base and receiving said light emitting chip therein;
an optical element positioned in said luminous path; and
a destruct structure formed on at least one surface of said optical element.

5. The light emitting device as claimed in claim 4, wherein said destruct structure is a scorching artifact or a lumpy structure.

6. The light emitting device as claimed in claim 4, wherein said optical element is a transparent element or a light reflecting element.

7. The light emitting device as claimed in claim 4, wherein said base comprises:
a substrate;
a first metallic contact disposed on a top surface of said substrate, said light emitting chip mounted on and connected to said first metallic contact;
a second metallic contact disposed on said top surface of said substrate;
a wire bone interconnected between said light emitting chip and said second metallic contact; and
an encapsulant mounted on said substrate and covering said light emitting chip.

8. A method of manufacturing a light emitting device, comprising:
setting a threshold of luminous intensity; measuring luminous intensity of a measured light emitting device;
calculating an offset value between said threshold of luminous intensity and said measured luminous intensity of said measured light emitting device; and
performing a destruct structure capable of decreasing energy of light beam on a surface of an optical element of said measured light emitting device, wherein the energy decreasing efficiency of said destruct structure is direct proportion to said offset value.

9. The method of manufacturing a light emitting unit as claimed in claim 8,
wherein said method of performing said destruct structure comprising:
setting a threshold range of luminous intensity; and
forming a scorching artifact on said optical element by radiating laser beam if said measured luminous intensity of said measured light emitting device being over said threshold range of luminous intensity, wherein said energy decreasing efficiency with respect to a light absorbing ratio of said scorching artifact is direct proportion to the amount or area of said scorching artifact.

10. The method of manufacturing a light emitting unit as claimed in claim 9, wherein said optical element is a light emitting chip, said scorching artifact is formed on a light emitting surface of said light emitting chip.

11. The method of manufacturing a light emitting unit as claimed in claim 9, wherein said optical element is an encapsulant, said scorching artifact is formed on a light emitting surface of said encapsulant.

12. The method of manufacturing a light emitting unit as claimed in claim 9, wherein said optical element is a transparent optical element, said scorching artifact is formed on a surface of said transparent optical element.

13. The method of manufacturing a light emitting unit as claimed in claim 9, wherein said optical element is a light reflecting element, said scorching artifact is formed on a surface of said light reflecting element.

14. The method of manufacturing a light emitting unit as claimed in claim 8, wherein said method of performing said destruct structure comprising:
setting a threshold range of luminous intensity; and
forming a lumpy structure on said optical element by micro sand blasting if said measured luminous intensity of said measured light emitting device being over said threshold range of luminous intensity, wherein said energy decreasing efficiency with respect to a light scattering coefficient of said lumpy structure is direct proportion to the amount or area of said lumpy structure.

15. The method of manufacturing a light emitting unit as claimed in claim 14, wherein said optical element is a light emitting chip, said lumpy structure is formed on a light emitting surface of said light emitting chip.

16. The method of manufacturing a light emitting unit as claimed in claim 14, wherein said optical element is an encapsulant, said lumpy structure is formed on a light emitting surface of said encapsulant.

17. The method of manufacturing a light emitting unit as claimed in claim 14, wherein said optical element is a transparent optical element, said lumpy structure is formed on a surface of said transparent optical element.

18. The method of manufacturing a light emitting unit as claimed in claim 14, wherein said optical element is a light reflecting element, said lumpy structure is formed on a surface of said light reflecting element.

19. The method of manufacturing a light emitting unit as claimed in claim 8, wherein said optical element is a light emitting chip or a light transparent element or a light reflecting element.
